(19) United States
(12) Patent Application Publication
(10) Pub. No.: US 2018/0113947 A1
(43) Pub. Date: Apr. 26, 2018

(54) METHOD AND DEVICE FOR PERFORMING FOR SEARCHING OF AT LEAST ONE KEYWORD WITHIN A CONTENT

(71) Applicant: Samsung Electronics Co., Ltd., Suwon-si (KR)

(72) Inventors: Gitanshu MEHNDIRATTA, Noida (IN); Avinash KUMAR, Noida (IN); Debashish SAMANTARAY, Noida (IN)

(21) Appl. No.: 15/793,757

(22) Filed: Oct. 25, 2017

(30) Foreign Application Priority Data
Oct. 26, 2016 (IN) 201611036737

(51) Int. Cl. G06F 17/30

(52) U.S. Cl. CPC G06F 17/30873; G06F 17/30905; G06F 17/30887

(57) ABSTRACT

A method for searching for at least one keyword. The method includes receiving a user input for searching within content, wherein the user input comprising at least one of a search mode and the at least one keyword. The method also includes determining a property associated with the search mode, wherein the property indicates that the search for the at least one keyword be restricted. The method additionally includes performing a search for the at least one keyword within the content according to the property associated with the searchable mode. The method also includes displaying information related to the performed search for the at least one keyword, wherein the search mode comprises a navigational mode, a non-navigational mode, or a normal mode.

### CROSS-REFERENCE TO RELATED APPLICATION AND CLAIM OF PRIORITY

This application is related to and claims priority to of Indian Patent Application No. 201611036737 filed on Oct. 26, 2016, the contents of which are incorporated herein by reference.

### TECHNICAL FIELD

The present disclosure generally relates to performing a search for one or more keywords within a web page content. More particularly, the present disclosure relates to a device and method for performing a search for the one or more keywords in either the navigational elements and/or the non-navigational elements.

### BACKGROUND

Till date, performing a search for the one or more keywords either in the navigational element or the non-navigational element has not been disclosed in the prior art. For example, if a user wants to perform a search for the one or more keywords only in navigational elements, it is not available. Similarly, if the user wishes to perform a search for the one or more keywords only in non-navigational elements, it is also not available. Moreover, performing a search for the one or more keywords in the attributes of html tags or information associated with the html tags is also not available.

Examples of prior arts include US20080021880 A1 and U.S. Pat. No. 8,259,124 B2. US 20080021880 A1 relates to searching and highlighting web page content, giving search index to searched content, giving an option to user to navigate on search index, giving comment on a particular search index wherein said comment can be associated with said particular search index, saving search index, text and comments on a file etc. U.S. Pat. No. 8,259,124 B2 relates to search and highlight web page content and applies high-level highlight to occurrences of one or more keywords in a search result that fades to a low-level highlight effect. The disclosure basically states about highlighting searched keyword to a normal level and then fading highlight to a level that is still noticeable but is less likely to distract the user from other elements of the user interface. Both the prior arts mentioned above do not provide an option to search for one or more keyword either in the navigational element or the non-navigational elements within the webpage. Also, both the prior arts do not disclose performing a search for the one or more keywords in the attributes of the html tags or information associated with the html tags.

FIGS. 1A-D illustrates methods for searching one or more key words within content of a webpage. FIGS. 1A-D illustrate how the prior art methods searches for the one or more key words within the webpage content. As can be seen in FIG. 1A, when the user performs a search for the keyword “ENGLAND”, a web browser retrieves a webpage 100 comprising content denoted by reference numeral 101, 102, 103 and 104. The content denoted by reference numeral 101 and 103 is navigational text and the content denoted by reference numeral 102 and 104 is non-navigational text. The search for the keyword “ENGLAND” is done in the navigational text as well as the non-navigational text as shown in FIG. 1B and matching text as shown in FIG. 1C is highlighted (represented by the dotted pattern) as shown in FIG. 1D. It can be seen that if the user is only interested in the navigational content within the webpage, such a search process is not efficient as it will consume time in searching and highlighting keywords in the non-navigational content which is of no interest to the user.

The prior arts further do not disclose performing a search for the one or more keywords in one or more html tags. For example, FIG. 2 illustrates methods for searching for one or more keywords within contents of a webpage. For example, when the user performs a search for the keyword “SAMSUNG”, navigational video 201 and 202 in the webpage 200 are not highlighted as the keyword SAMSUNG is not present in the visual content associated with said navigational videos 201 and 202. However, the keyword “SAMSUNG” is present in the attributes of html tags 203 and 204 associated with said navigational video 201 and 202 respectively. The keyword “SAMSUNG” in the source code 203 and 204 is denoted by reference numeral 205.

In view thereof, there is an unmet need for a device and method that overcomes the disadvantages of the prior art and provides a simple and efficient way of searching the one or more keywords either in the navigational elements or the non-navigational elements within the webpage content. Further, the device and method should be capable of performing a search for the one or more keywords in one or more html tags associated with the webpage content. The device and method should also be capable of performing a search for the one or more keyword in the information associated with the said webpage.

### SUMMARY

To address the above-discussed deficiencies, it is a primary object to provide a user an option to search for the one or more keywords in either the navigational element or the non-navigational element. FIGS. 3A-D, 4A-D, and 5A-D clearly illustrate the object of the present disclosure. FIG. 3A illustrates when a search for the one or more keyword is performed in the navigational element as well as the non-navigational element. As can be seen in FIG. 3A, when the user performs a search for the keyword “SAMSUNG”, a web browser retrieves a webpage 300 comprising contents denoted by reference numeral 301, 302, 303 and 304. The content denoted by reference numeral 301 and 303 is navigational text and the content denoted by reference numeral 302 and 304 is non-navigational text. The search for the keyword “SAMSUNG” is done in the navigational text as well as the non-navigational text as shown in FIG. 3B and matching text as shown in FIG. 3C is highlighted (represented by the diagonal lines) as shown in FIG. 3D.

FIG. 4 block diagrams of searching for key words, according to an example embodiment of the present disclosure. FIG. 4 illustrates the present disclosure wherein the search for the one or more keyword is performed only in the navigational elements within the webpage content. As can be seen in FIG. 4A, when the user performs a search for the keyword “SAMSUNG”, a web browser retrieves a webpage 400 comprising contents denoted by reference numeral 401, 402, 403 and 404. The content denoted by reference numeral 401 and 403 is navigational text and the content denoted by reference numeral 402 and 404 is non-navigational text. The search for the keyword “SAMSUNG” is done only in the navigational text i.e. 401 and 403 and not in the non-navigational text as shown in FIG. 4B and matching text as shown in FIG. 4C is highlighted (represented by the diagonal lines) as shown in FIG. 4D.

FIG. 5 illustrates block diagrams of searching for key words, according to an example embodiment of the present disclosure. FIG. 5 illustrates the present disclosure wherein the search for the one or more keyword is performed only in the non-navigational elements within the webpage content. As can be seen in FIG. 5(a), when the user performs a search for the keyword “SAMSUNG”, a web browser retrieves a webpage 500 comprising contents denoted by reference numeral 501, 502, 503 and 504. The content denoted by reference numeral 501 and 503 is navigational text and the content denoted by reference numeral 502 and 504 is non-navigational text. The search for the keyword “SAMSUNG” is done only in the non-navigational text i.e. 502 and 504 and not in the navigational text as shown in FIG. 5(b) and matching text as shown in FIG. 5(c) is highlighted (represented by the diagonal lines) as shown in FIG. 5(d).

Another object of the present disclosure is to perform a search for the one or more keywords in the one or more html tags. Performing a search in the one or more html tags provides an option to the user to perform a search either in the navigational elements and/or the non-navigational elements. For example, if the user wants to perform a search only in the navigational elements, the present disclosure will perform a search only in the navigational html tags such as <a>, input element <input>, select element <select>, text area element <text area>, anchor element <button>, area element <a> and button element <area>. In case, the user wants to perform a search only in the non-navigational elements, the present disclosure will perform a search only in non-navigational html tags such as Division element <div>, line element <li>, span element <span>, paragraph element <p>, header element <hl> and the title element <title>.

The search can be further filtered down to element types such as text, image or video by using the attribute property of the html tags. For example, if only a navigational image is to be searched, the present disclosure allows the search to be performed in navigational tags having attribute property related to image such as src and alt. The search for the one or more keywords is performed in the attribute value of the attribute property. The search for the one or more keyword can also be performed in information associated with the html tags. The information may include content of the “destination page” indicated by the attribute value of the html tags.

Yet another object of the present disclosure is to minimize user's effort to reach desired content. The user, apart from being given an option to search in the navigational elements or the non-navigational elements, is also given an option to perform the search in one or more element type: text, image and video. It is to be noted that option to perform a search in one or more element types is selected subsequent to selection of an option to perform a search in the navigational elements and/or the non-navigational elements. This enhances experience of user while performing a search for the one or more keywords within webpage content.

These and other objects as well as advantages will be more clearly understood from the detailed description taken in conjugation with the accompanying drawings and claims.

In accordance with the present disclosure as embodied and broadly described herein, comprises devices and methods for performing a search for the one or more keywords within the web page content.

In one embodiment, the disclosure discloses a method performed during searching of one or more keywords within a web page content, said method comprising fetching a property associated with a search mode, the property indicating that the search for the one or more keyword be restricted to: navigational element(s) present in the web page content and/or non-navigational element(s) present in the web page content and performing a search for the one or more keyword in one or more html tags. The said html tags are associated with the web page content and have a tag property matching with the property associated with the search mode.

In yet another embodiment, the present invention discloses a device for searching of one or more keywords within a web page content, said device comprising: a fetching module for fetching a property associated with a search mode, the property indicating that the search for the one or more keyword be restricted to: navigational element(s) present in the web page content; and/or non-navigational element(s) present in the web page content and a searching module for searching for the one or more keyword in one or more html tags. The said html tags are associated with the content and having a tag property matching with the property associated with the search mode.

These and other aspects of the present disclosure will be more clearly understood from the following detailed description taken in conjugation with the accompanying drawings and claims.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1A-D illustrate methods for searching one or more key words within content of a webpage;

FIG. 2 illustrate methods for searching one or more key words within content of a webpage;

FIGS. 3A-D illustrate block diagrams of searching for key words, according to an example embodiment of the present disclosure;

FIGS. 4A-D illustrate block diagrams of searching for key words, according to an example embodiment of the present disclosure;

FIGS. 5A-D illustrate block diagrams of searching for key words, according to an example embodiment of the present disclosure;

FIG. 6 illustrates a flowchart for searching the one or more keywords within web page content, in accordance with an embodiment of the present disclosure;

FIG. 7 illustrates a block diagram, in accordance with an embodiments of the present disclosure;

FIG. 8 illustrates an embodiment for searching for one or more keywords, in accordance with an embodiments of the present disclosure;

FIG. 9 illustrates an exemplary hardware configuration of a computing device, in accordance with an embodiments of the present disclosure;

FIG. 10 illustrate Graphical User Interfaces (GUI) having selectable options, in accordance with an embodiments of the present disclosure;

FIG. 11 illustrate Graphical User Interfaces (GUI) having selectable options, in accordance with an embodiments of the present disclosure;

FIG. 12 illustrates a HTML source code of webpage and performing a search for the one or more keyword in the HTML source code, in accordance with an embodiment of the present disclosure;

FIG. 13 illustrates performing a search for the one or more keywords in the navigational elements present in the webpage content, in accordance with an embodiments of the present disclosure;

FIG. 14 illustrates performing a search for the one or more keywords in the non-navigational elements present in the webpage content, in accordance with an embodiment of the present disclosure;

FIG. 15 illustrates performing a search for the one or more keywords in the navigational as well as non-navigational elements present in the webpage content, in accordance with an embodiment of the present disclosure;

FIG. 16 illustrates performing a search for the one or more keywords in the html tags, in accordance with an embodiment of the present disclosure;

FIG. 17 illustrates performing a search for the one or more keywords in the information associated with the html tags, in accordance with an embodiment of the present disclosure;

FIG. 18 illustrates viewing the one or more contents comprising one or more keyword in a pre-view pane, in accordance with an embodiment of the present disclosure; and

FIG. 19 illustrates auto-playing one or more navigational videos comprising the one or more keyword, in accordance with an embodiment of the present disclosure.

It may be noted that to the extent possible, like reference numerals may have been used to represent like elements in the drawings. Further, those of ordinary skill in the art will appreciate that elements in the drawings are illustrated for simplicity and may not have been necessarily drawn to scale. For example, the dimensions of some of the elements in the drawings may be exaggerated relative to other elements to help to improve understanding of aspects of the disclosure. Furthermore, the one or more elements may have been represented in the drawings by conventional symbols, and the drawings may show only those specific details that are pertinent to understanding the embodiments of the invention so as not to obscure the drawings with details that will be readily apparent to those of ordinary skill in the art having benefit of the description herein.

### DETAILED DESCRIPTION

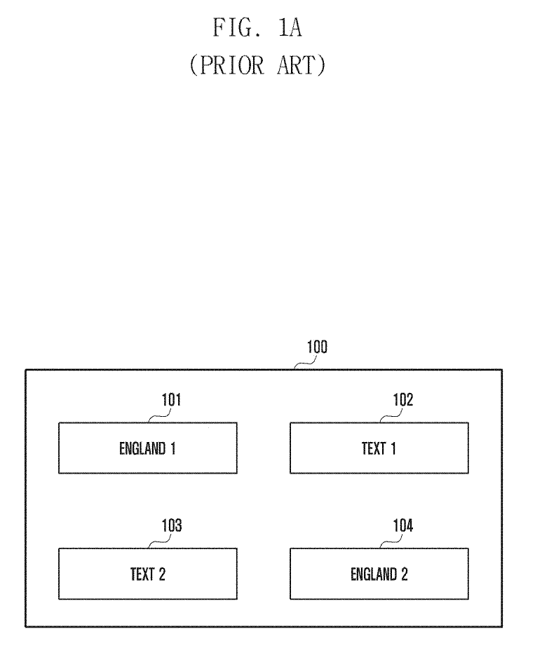

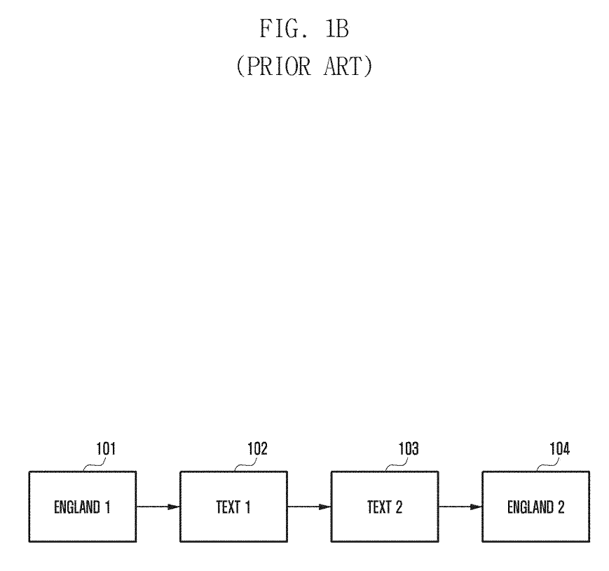

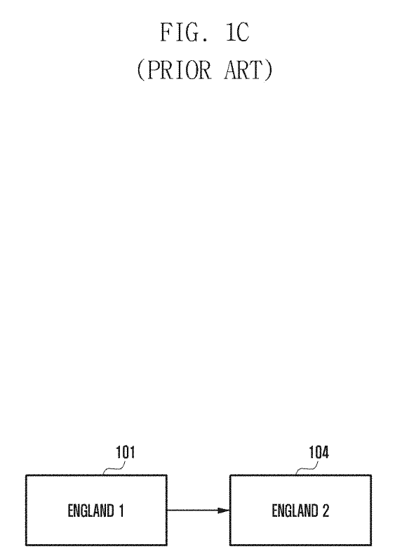

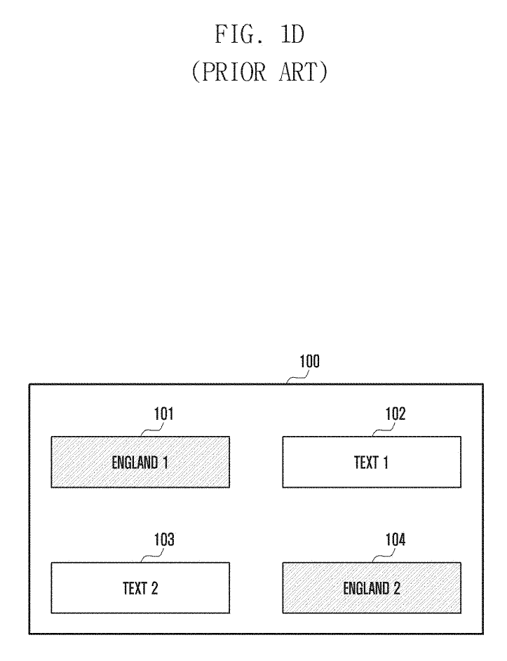

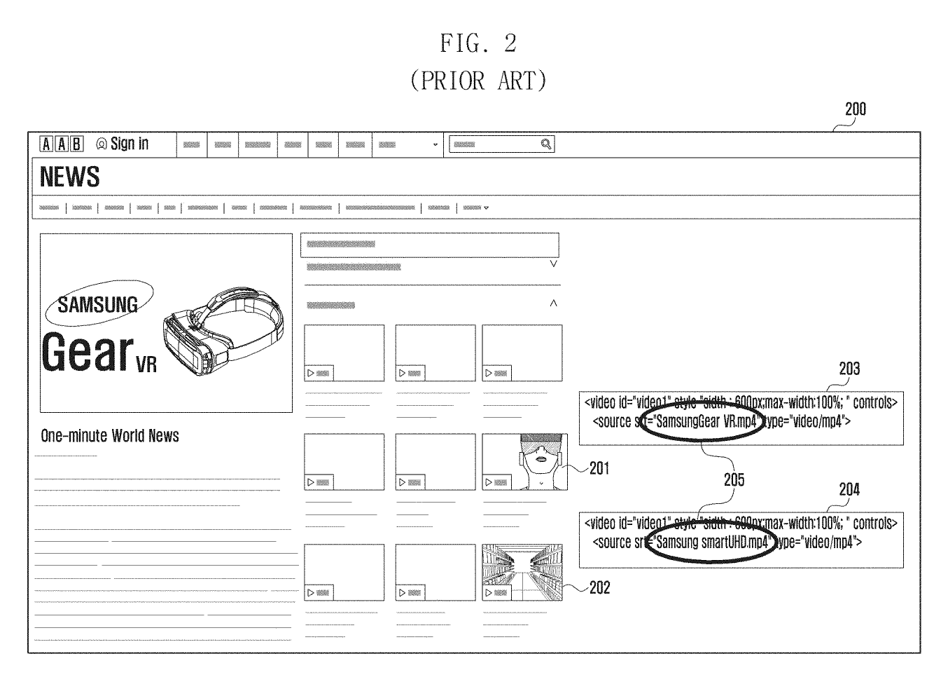

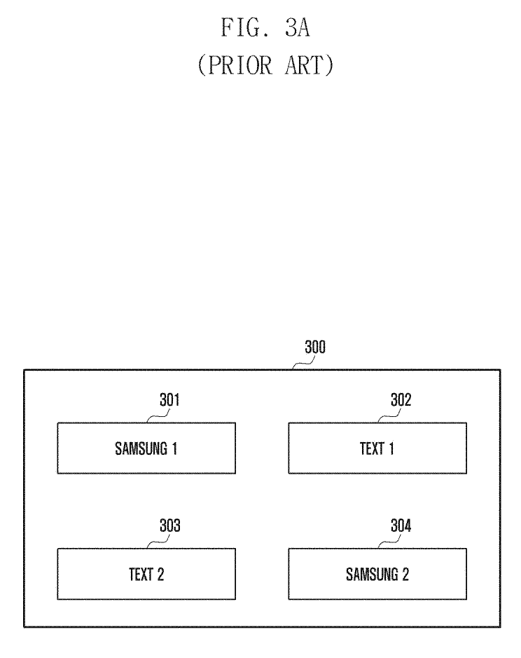

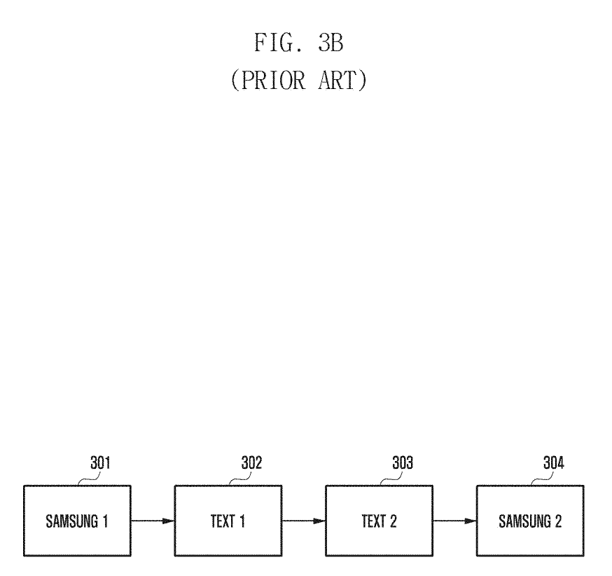

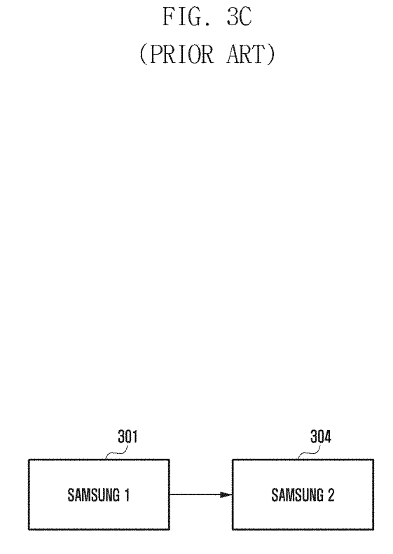

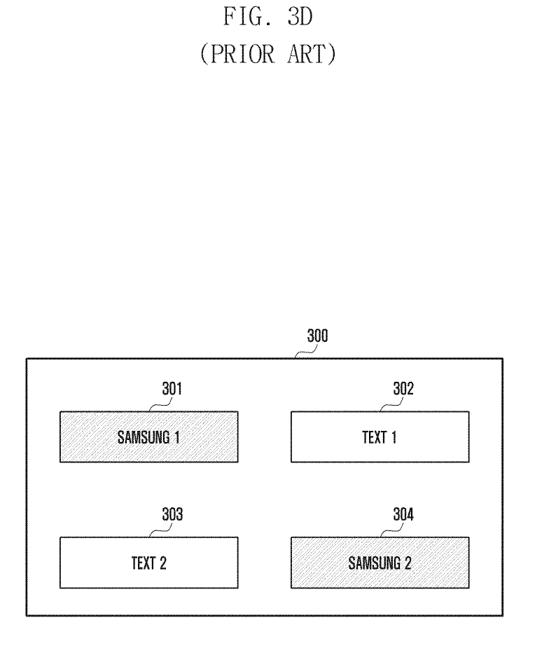

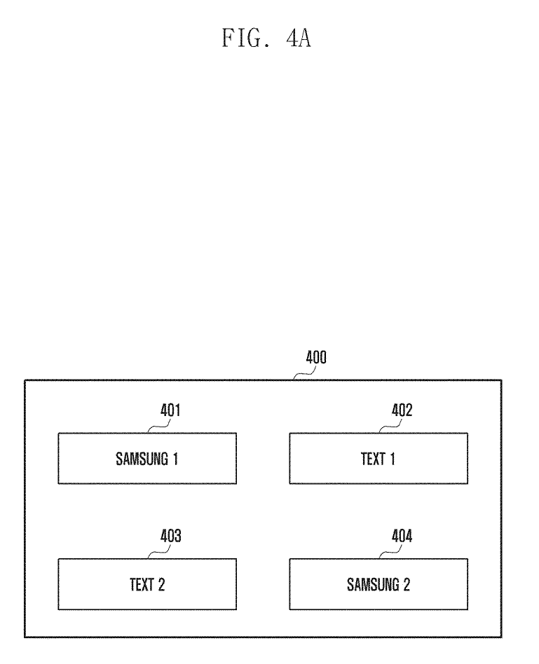

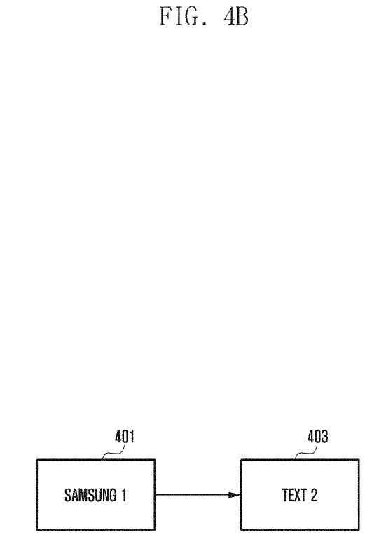

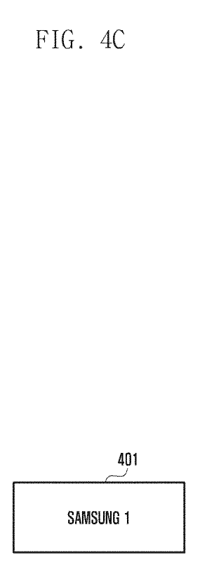

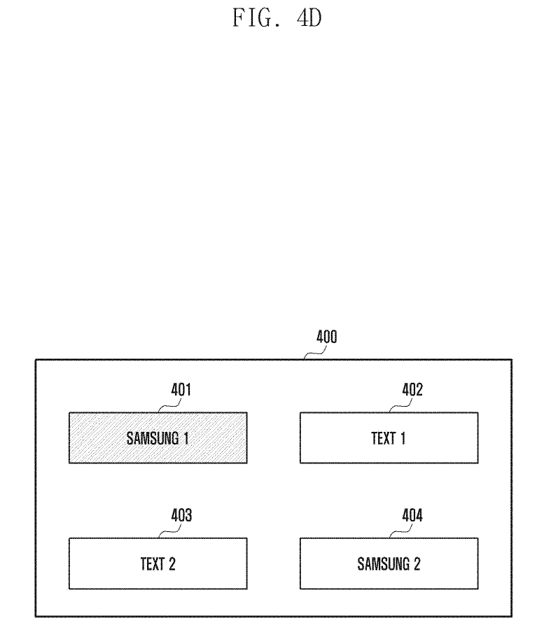

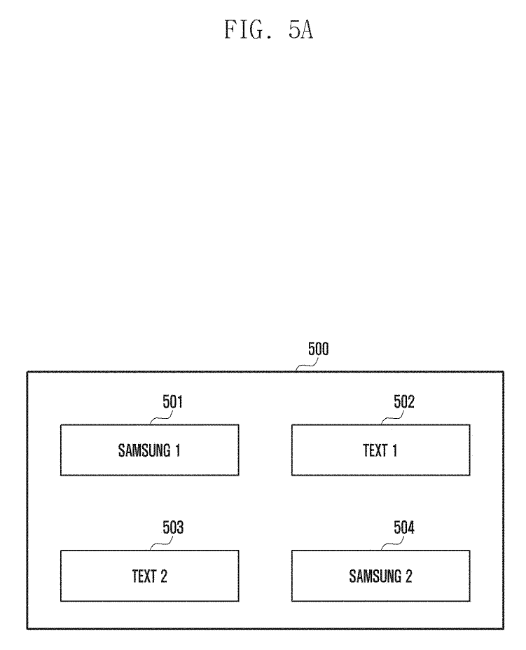

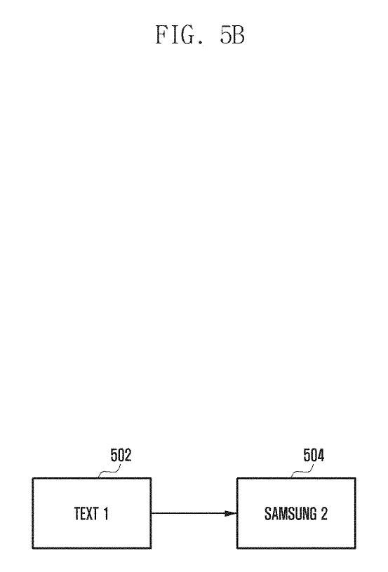

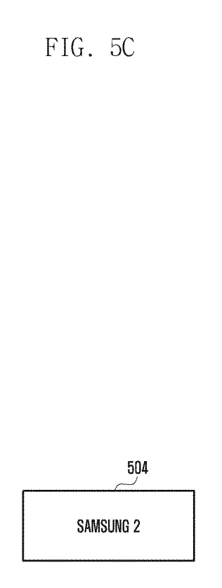

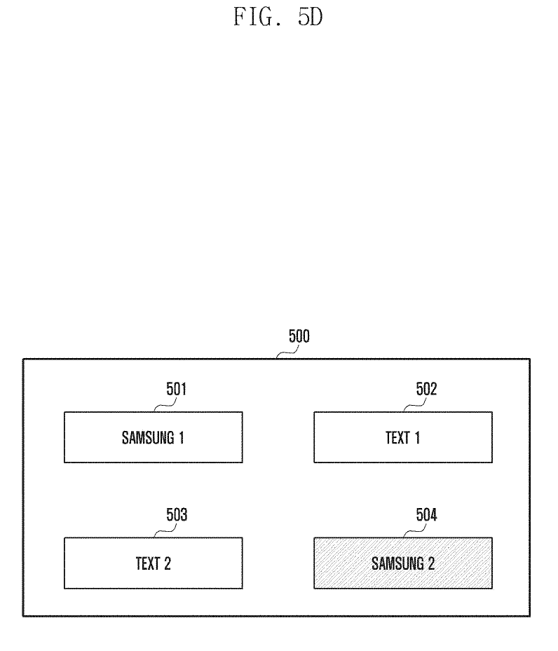

FIGS. 1 through 19, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

It should be understood at the outset that although illustrative implementations of the embodiments of the present disclosure are illustrated below, the present invention may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents. The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments”. The terminology and structure employed herein is for describing, teaching and illuminating some embodiments and their specific features and elements and does not limit, restrict or reduce the spirit and scope of the claims or their equivalents. More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way it may still be referred to as “one or more features” or “one or more elements” or “at least one feature” or “at least one element.” Furthermore, the use of the terms “one or more” or “at least one” feature or element do NOT preclude there being none of that feature or element, unless otherwise specified by limiting language such as “there NEEDS to be one or more . . . ” or “one or more element is REQUIRED. Unless otherwise defined, all terms, and especially any technical and/or scientific terms, used herein may be taken to have the same meaning as commonly understood by one having an ordinary skill in the art. Reference is made herein to some “embodiments.” It should be understood that an embodiment is an example of a possible implementation of any features and/or elements presented in the attached claims. Some embodiments have been described for the purpose of illuminating one or more of the potential ways in which the specific features and/or elements of the attached claims fulfill the requirements of uniqueness, utility and non-obviousness. Use of the phrases and/or terms such as but not limited to “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or variants thereof do NOT necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any features and/or elements described in the context of separate embodiments may alternatively be realized as existing together in the context of a single embodiment. Any particular and all details set forth herein are used in the context of some embodiments and therefore should NOT be necessarily taken as limiting factors to the attached claims. The attached claims and their legal equivalents can be realized in the context of embodiments other than the ones used as illustrative examples in the description below.

FIG. 6 illustrates a flowchart for searching one or more keywords within web page content, in accordance with an embodiment of the present disclosure.

At step 601, the method comprises fetching a property associated with a search mode, the property indicating that the search for the one or more keyword be restricted to: navigational element(s) present in the web page content and/or non-navigational element(s) present in the web page content. It is to be noted that the webpage content includes visual content of the web page and one or more attributes associated with the visual content. The visual content includes viewable area of the webpage as well as scrollable area of the webpage.

At step 602, the method comprises performing a search for the one or more keyword in one or more html tags, said html tags associated with the web page content and having a tag property matching with the property associated with the search mode. The tag property is statistically or dynamically categorized as navigational property or non-navigational property. Navigational property makes html tags focusable, which helps in navigation through tab (keyboard) or remocon (TV Remote) user interface on web browser. This property is achieved statistically as well as dynamically. Navigational property can also be achieved through javascript and css [.focus( ) and tab index respectively] on non-navigational elements and such html tags are termed as dynamic navigational tags. The html tags having default property such as <a>, <input> are static navigational tags. The non-navigational tags include tags corresponding to Division element <div>, line element <li>, span element <span>, paragraph element <p>, header element <hl> and the title element <title>.

Further, the step of performing the search for the one or more keywords in the one or more html tag comprises fetching all html tags associated with the content as shown at step 603 (a). At step 604 (a), the method comprises performing a first search on the html tags thus fetched to obtain a first set of html tags, each of the first set of html tags having the tag property matching with the property of the search mode. At step 605 (a), the method comprises performing a second search on the first set of html tags to obtain a second set of html tags, each of the second set of html tags including the one or more keywords.

Alternatively, the step of performing the search for the one or more keywords in the one or more html tag comprises fetching all html tags associated with the content as shown at step 603(b). At step 604(b), the method comprises performing a first search on the html tags thus fetched to obtain a first set of html tags, each of the first set of html tags including the one or more keyword. At step 605(b), the method comprises performing a second search on the first set of html tags to obtain a second set of html tags, each of the second set of html tags having the tag property matching with the property of the search mode.

The present disclosure provides an opportunity to the user to search for the one or more keywords either in the navigational elements and/or the non-navigational elements. For example, if the user defines a search mode as the navigational mode, the search for the one or more keywords may be performed only in the navigational html tags associated with the webpage content and not in the non-navigational html tags. Similarly, if the user defines a search mode as the non-navigational mode, the search for the one or more keywords will be performed only in the non-navigational html tags. The present disclosure further allows filtering a search for the one or more keyword in element types such as text, image and video. The navigational elements include navigational text, navigational image and navigational video and are defined as navigational element types. The non-navigational elements include non-navigational text and non-navigational image and are defined as non-navigational types. The attribute property of the html tags allows performing a search for the one or more keyword in the element types. For example, if the user defines a search mode as the navigational image, the search for the one or more keywords will be performed in navigational tags which are images.

The method 600 may further comprise retrieving or receiving one or more keywords. The method 600 may further comprise visually distinguishing an area on the webpage containing the one or more keyword from an area on the webpage devoid of the one or more keyword. The method 600 may further comprise visually distinguishing an area on the webpage containing the one or more keywords as navigational element from an area on the webpage containing the one or more keyword as non-navigational element. The method may further comprise visually distinguishing an area on the webpage containing the one or more keyword as non-navigational element from an area on the webpage containing the one or more keyword as navigational element. The method may further comprise visually distinguishing an area on the webpage containing a first keyword from an area on the webpage containing a second key word. The method may further comprise visually distinguishing an area on the webpage containing first keyword as navigational element from an area on the webpage containing a second keyword as non-navigational element. The method may further comprise displaying the one or more navigational elements containing the one or more keywords in one or more pre-view panes or user interfaces. The method may further comprise auto-playing contents of one or more navigational images in one or more user interfaces. The method may further comprise auto-playing contents of one or more navigational videos in one or more user interfaces.

The term “visually distinguishing” includes distinguishing by means of one or more: font changes, effects, colour changes and the likes. The font changes may include change in font size or font style of the text matching the one or more keyword in the webpage content. Effects such as shadows, outline, 3D effects and the likes may also be provided to the text matching the one or more keyword in the webpage content. Colour changes include change in foreground color or background colour of the text matching the one or more keyword. The above mentioned examples are not to be taken as limiting and the term “visual distinguishing” includes other means of visual distinguishing known in the prior arts.

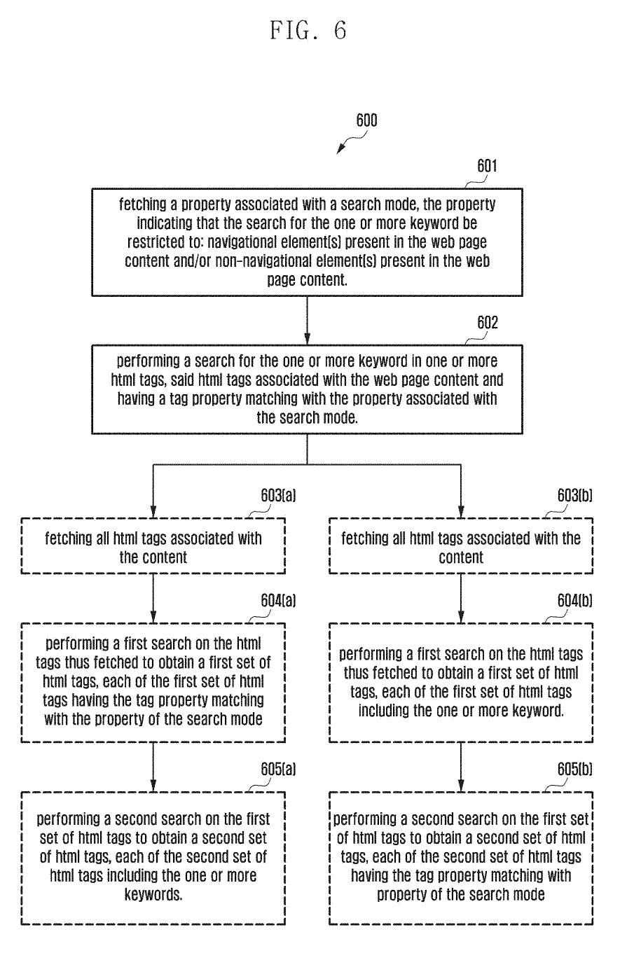

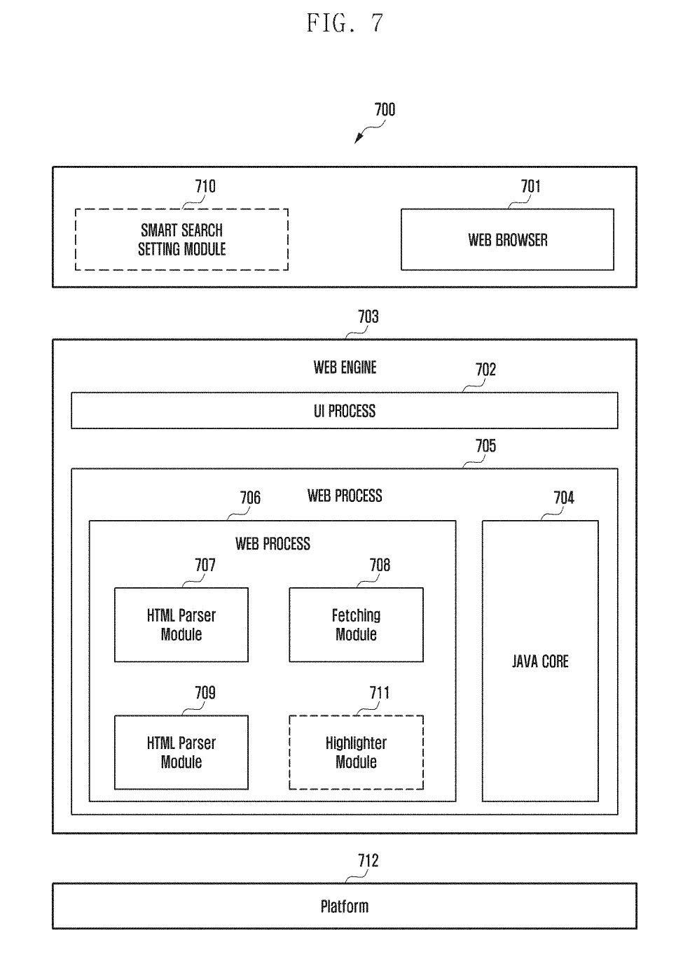

FIG. 7 illustrates a block diagram in accordance with an embodiment of the present disclosure.

A web browser 701 is a software application for retrieving, presenting, and traversing information resources on the World Wide Web (www). The web browser includes a user interface (UI) process 702, a web browser engine 703, Java core 704 (also known as Javascript interpreter), web process 705 and a web core 706. The web core 706 is a layout, rendering, and document object model (DOM) library for Hypertext Markup Language (HTML). The web core 706 comprises a HTML parser module 707. As already known, an HTML document may contain text and/or refer to images. A word or a phrase of text, an image, or a part of an image can be a hypertext anchor. The hypertext anchors and other objects which are to be displayed on a screen are defined in the HTML document by a number of “tags” which specify information relating to the displayable object and its attributes i.e. whether the object is a hypertext anchor, an image map, an image map containing hypertext anchors etc. The nodes of every HTML document are organized in a tree structure called the DOM tree which is generated by the HTML parser module. Javascript core is a framework that provides computer software in interpreting and executing Javascript. The web browsers can display any kind of content including images, audio, video, and extensible Markup Language (XML) files, and often have plugs-ins to support flash applications and Java applets.

Further, the web browser engine 703 also called as layout engine is a software component that takes up marked up content such as HTML, extensible Markup language (XML), and image file and formatting information such as cascading style sheets (CSS), extensible style sheet (XSL) and displays the formatted content on the screen. A platform 712 for the web browser can be one of HTML, CSS, DOM and Javascript. Example of web browsers include but are not limited to Internet Explorer™, Mozilla™, Firefox™, Safari™, Google Chrome™, Konqueror™, Arora™, Dillo™, Lynx™, Amaya™, Netpositive™, Planetweb™ and Netscape™.

The device 700 of the present disclosure, apart from the above-mentioned which is already known in the art, comprises a fetching module 708 and a searching module 709. The device 700 may further comprise a smart search setting module 710 and a highlighter module 711.

The smart search setting module 710 is configured for providing the user with a Graphical User Interface (GUI) having selectable options. The selectable options include one or more: navigational mode, non-navigational mode and default mode. The default mode includes navigational as well as non-navigational modes. The selectable options further include filtering options such as text, image and videos. The said filtering options enable the user to restrict the search to one or more elements such as text, image or video. The selectable options may further include one or more: options to auto-play one or more navigational videos, options to view contents of webpage having the one or more keywords in a pre-view pane, options for multi-level searches, options for saving a plurality of navigational links and the likes. The GUI further provides one or more text field for entering one or more keywords. The user selects one or more selectable options in the GUI to define a search mode. For example, if the user wants to search for the one or more keywords only in the navigational image, the user will select the navigational mode and image in the filtering option to define a search mode. In another example, if the user wants to perform a search only in the non-navigational text, the user will select the non-navigational mode and text in the filtering option to define a search mode. It is to be understood that options mentioned above are not to be construed as limiting and other options can also be provided.

The smart search setting module 710 may further comprise a data processing unit to process the search mode and define a property. The said property indicates that the search for the one or more keyword be restricted to: navigational element(s) present in the web page content and/or non-navigational element(s) present in the web page content. The said property may further define the selected options to auto-play one or more navigational videos, options to view contents of webpage having the one or more keywords in a pre-view pane, options for multi-level searches, multi key searches, saving a plurality of navigational links.

The fetching module 708 is in operable interconnection with the smart search setting module 710 and the searching module 709. The fetching module 708 is configured for fetching the property associated with the search mode from the smart search setting module 710 and providing said property to the searching module.

The searching module 709 is in operable interconnection with the fetching module 708 and/or the HTML parser module 707 in the web core 706. In order to implement method 600, the searching module receives said property from the fetching module and in accordance with the said property searches for the one or more keywords in the DOM tree prepared by the HTML parser module 707.

The highlighter module 711 is in operable interconnection with the searching module and is configured for one or more: (i) visually distinguish an area on the webpage containing the keyword from an area on the webpage devoid of the one or more keyword, (ii) visually distinguishing an area on the webpage containing the one or more keyword as navigational element from an area on the webpage containing the one or more keyword as non-navigational element, (iii) visually distinguishing an area on the webpage containing the one or more keyword as navigational element from an area on the webpage containing the one or more keyword as non-navigational element, (iv) visually distinguishing an area on the webpage containing a first keyword from an area on the webpage containing a second key word, and (v) visually distinguishing an area on the webpage containing first keyword as navigational element from an area on the webpage containing a second keyword as non-navigational element.

The options for visual distinguishing include one or more: font changes, effects, color change and the likes. The font changes may include change in font size or font style of the text matching the one or more keyword in the webpage content. Effects such as shadows, outline, 3D effects and the likes may also be provided to the text matching the one or more keyword in the webpage content. Colour changes include change in foreground colour or background colour of the text matching the one or more keyword. The above mentioned examples are not to be taken as limiting and the term “visual distinguishing” includes other means of visual distinguishing known in the prior arts.

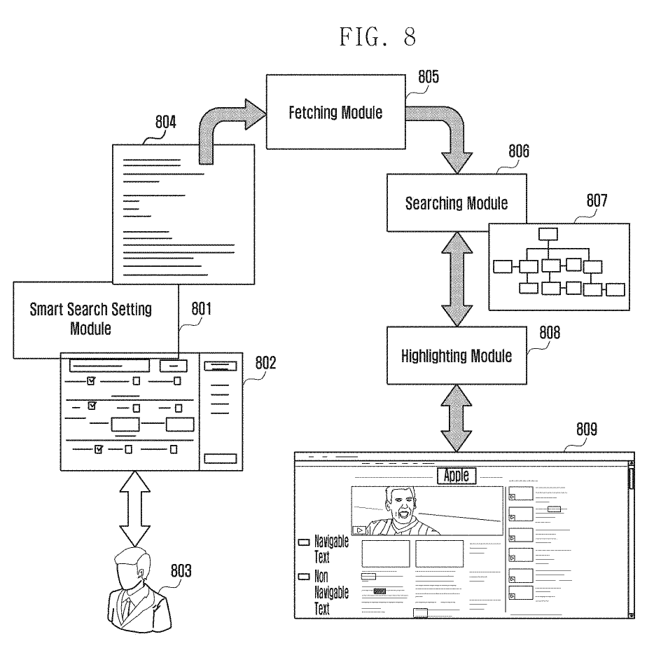

FIG. 8 illustrates an embodiment for searching for one or more keywords, in accordance with an embodiment of the present disclosure.

As illustrated, the smart search setting module 801 provides GUI 802 to the user 803. The GUI may automatically be provided to the user or the user may manually open the GUI to select one or more option and/or enter one or more keywords. The selected options may also be pre-set/factory set or retained from a previous search. The said one or more options selected by the user defines a search mode. The smart search setting module 801 further stores the information in a data structure 804. The fetching module 805 fetches the information stored in the data structure 804 property associated with the smart search setting module 801 and provides the same to the searching module 806.

The web browser retrieves the webpages from a webserver. The HTML parser module of the web browser generates a DOM tree structure for the webpages so retrieved. The searching module 806, in accordance with the information, performs a search for the one or more keywords in the DOM tree structure. The DOM tree structure is denoted by reference numeral 807. The step of performing the search for the one or more keywords comprises fetching all html tags associated with the content and performing a first search on the html tags thus fetched to obtain a first set of html tags, each of the first set of html tags having the tag property matching with the property of the search mode. The method further comprises performing a second search on the first set of html tags to obtain a second set of html tags, each of the second set of html tags including the one or more keywords.

Alternatively, the step of performing the search for the one or more keywords in the one or more html tag comprises fetching all html tags associated with the content and performing a first search on the html tags thus fetched to obtain a first set of html tags, each of the first set of html tags including the one or more keyword. The method further comprises performing a second search on the first set of html tags to obtain a second set of html tags, each of the second set of html tags having the property of the search mode.

The searching module 806 works in operable interconnection with the highlighter module 808 to visually distinguish the one or more keywords in the retrieved webpage 809.

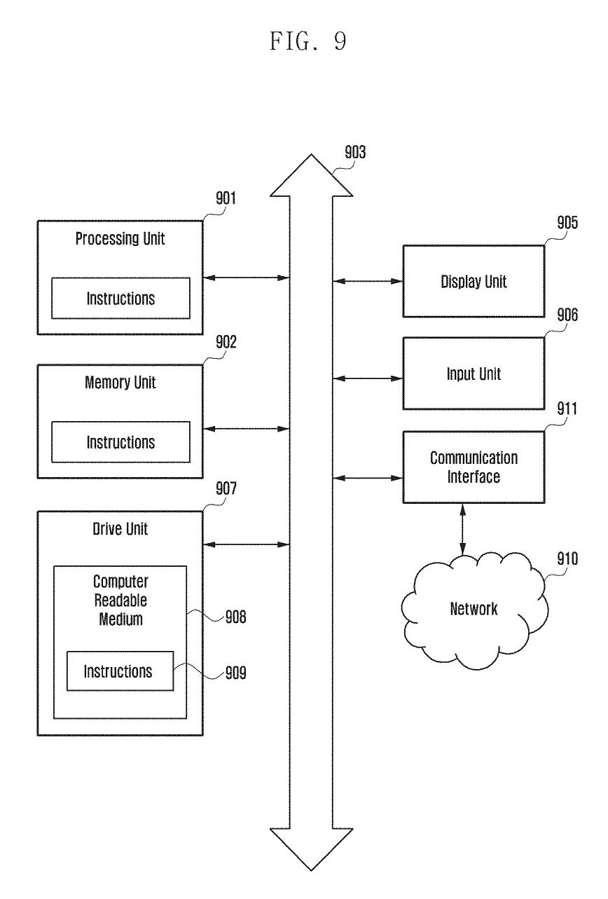

FIG. 9 illustrates an example hardware configuration of a computing device, in accordance with an embodiment of the present disclosure. The computer system 900 can include a set of instructions that can be executed to cause the computer system 900 to perform any one or more of the methods disclosed. The computer system 900 may operate as a standalone device or may be connected, e.g., using a network, to other computer systems or peripheral devices.

In a networked deployment, the computer system 900 may operate in the capacity of a server or as a client user computer in a server-client user network environment, or as a peer computer system in a peer-to-peer (or distributed) network environment. The computer system 900 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. Further, while a single computer system 900 is illustrated, the term “device” shall also be taken to include any collection of systems or sub-systems that individually or jointly execute a set, or multiple sets, of instructions to perform one or more computer functions.

The computer system 900 may include a processor 901, e.g., a central processing unit (CPU), a graphics processing unit (GPU), or both. The processor 901 may be a component in a variety of systems. For example, the processor 901 may be part of a standard personal computer or a workstation. The processor 901 may be one or more general processors, digital signal processors, application specific integrated circuits, field programmable gate arrays, servers, networks, digital circuits, analog circuits, combinations thereof, or other now known or later developed devices for analysing and processing data The processor 901 may implement a software program, such as code generated manually (i.e., programmed).

The computer system 900 may include a memory 902, such as a memory 902 that can communicate via a bus 903. The memory 902 may be a main memory, a static memory, or a dynamic memory. The memory 902 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, the memory 902 includes a cache or random access memory for the processor 901. In alternative examples, the memory 902 is separate from the processor 901, such as a cache memory of a processor, the system memory, or other memory. The memory 902 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 902 is operable to store instructions executable by the processor 901. The functions, acts or tasks illustrated in the figures or described may be performed by the programmed processor 901 executing the instructions stored in the memory 902. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 900 may further include a display unit 905, such as a liquid crystal display (LCD), an organic light emitting diode (OLED), a flat panel display, a solid state display, a cathode ray tube (CRT), a projector, a printer or other now known or later developed display device for outputting determined information. The display unit 905 may act as an interface for the user to see the functioning of the processor 901, or specifically as an interface with the software stored in the memory 902 or in a drive unit 907.

The computer system 900 may also include a disk or optical drive unit 907. The drive unit 907 may include a computer-readable medium 908 in which one or more sets of instructions 909, e.g. software, can be embedded. Further, the instructions 909 may embody one or more of the methods or logic as described. In a particular example, the instructions 909 may reside completely, or at least partially, within the memory 902 or within the processor 901 during execution by the computer system 900. The processor 901 and the memory 902 may also include computer-readable media as discussed above.

The present disclosure contemplates a computer-readable medium that includes instructions 909 or receives and executes instructions 909 responsive to a propagated signal so that a device connected to a network 910 can communicate voice, video, audio, images or any other data over the network 910. Further, the instructions 909 may be transmitted or received over the network 910 via a communication port or interface 911 or using the bus 903. The communication port or interface 911 may be a part of the processor 901 or may be a separate component. The communication interface 911 may be created in software or may be a physical connection in hardware. The communication interface 911 may be configured to connect with a network 910, external media, the display unit 905, or any other components in computer system 900, or combinations thereof. The connection with the network 910 may be a physical connection, such as a wired Ethernet connection or may be established wirelessly as discussed later. Likewise, the additional connections with other components of the computer system 900 may be physical connections or may be established wirelessly. The network 910 may alternatively be directly connected to the bus 903.

The network 910 may include wired networks, wireless networks, Ethernet AVB networks, or combinations thereof. The wireless network may be a cellular telephone network, an 802.11, 802.16, 802.20, 802.1Q or WiMax network. Further, the network 910 may be a public network, such as the Internet, a private network, such as an intranet, or combinations thereof, and may utilize a variety of networking protocols now available or later developed including, but not limited to TCP/IP based networking protocols.

Additionally, the computer system 900 may include an input device 906 configured to allow a user to interact with any of the components of computer system 900. The input device 906 may be a number pad, a keyboard, or a cursor control device, such as a mouse, or a joystick, touch screen display, remote control or any other device operative to interact with the computer system 900.

In an alternative example, dedicated hardware implementations, such as application specific integrated circuits, programmable logic arrays and other hardware devices, can be constructed to implement various parts of the computer system 900. Applications that may include the systems can broadly include a variety of electronic and computer systems. One or more examples described may implement functions using two or more specific interconnected hardware modules or devices with related control and data signals that can be communicated between and through the modules, or as portions of an application-specific integrated circuit. Accordingly, the present system encompasses software, firmware, and hardware implementations.

The system described may be implemented by software programs executable by a computer system. Further, in a non-limited example, implementations can include distributed processing, component/object distributed processing, and parallel processing. Alternatively, virtual computer system processing can be constructed to implement various parts of the system.

The system is not limited to operation with any particular standards and protocols. For example, standards for Internet and other packet switched network transmission (e.g., TCP/IP, UDP/IP, HTML, HTTP) may be used. Such standards are periodically superseded by faster or more efficient equivalents having essentially the same functions. Accordingly, replacement standards and protocols having the same or similar functions as those disclosed are considered equivalents thereof. It may be noted that the method as described in the present disclosure can be implemented in a wide variety of electronic devices including but not limited to desktop computers, lap top computers, palm top computers, tabs, mobile phones, televisions, etc. Also, the user input can be received by the system using a wide variety of techniques including but not limited to using a mouse, a gesture input, a touch input, a stylus input, a joy stick input, a pointer input, etc.

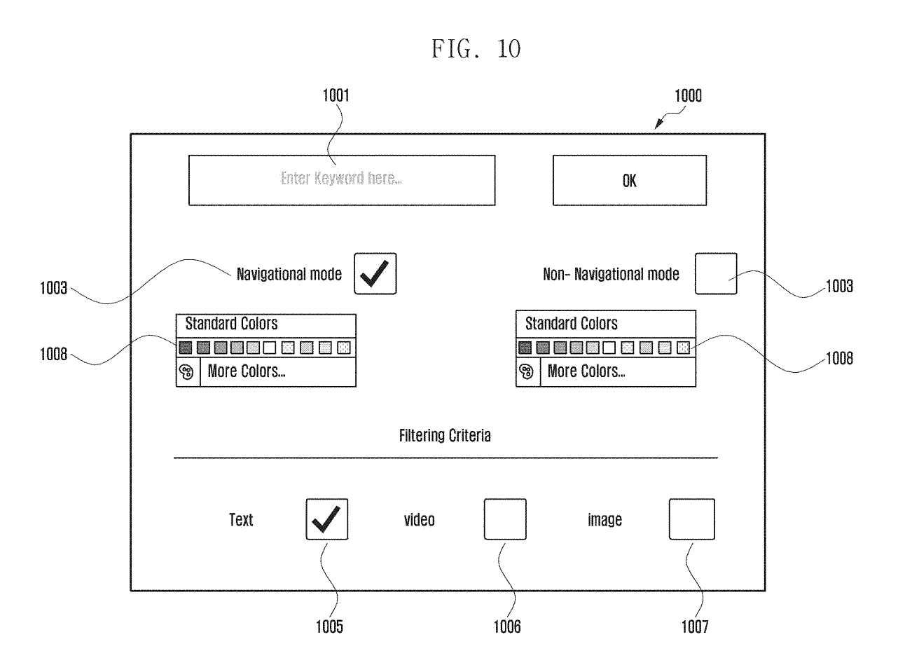

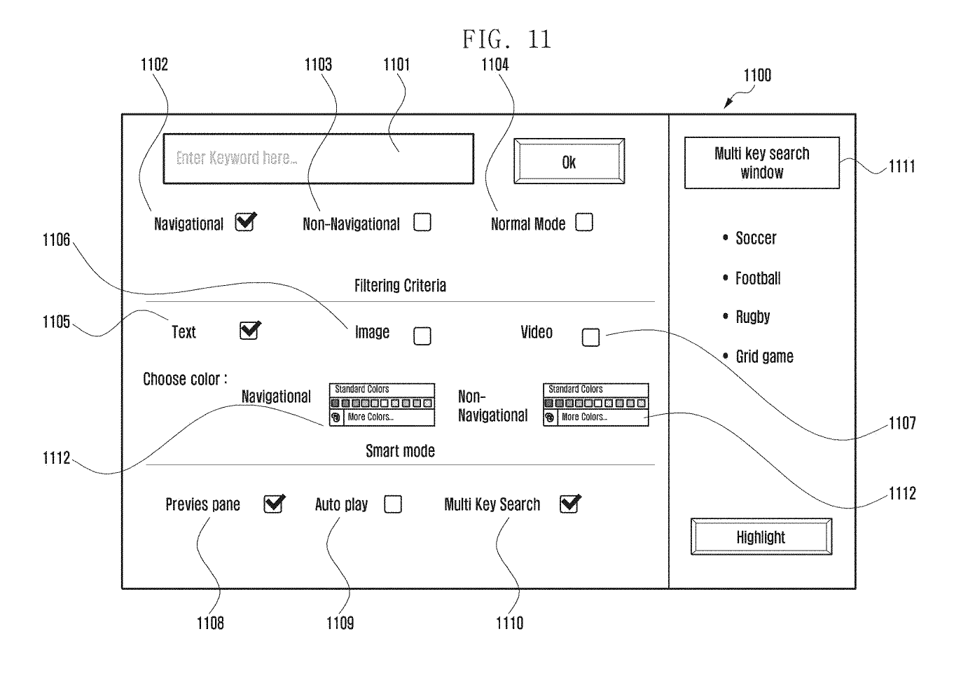

FIG. 10 and FIG. 11 illustrates examples of the Graphical User Interface (GUI) having selectable options, in accordance with embodiments of the present disclosure.

As illustrated in FIG. 10, the Graphic User Interface (GUI) 1000 comprises one or more selectable options. The GUI 1000 further comprises a text field 1001 for entering one or more keywords. The selectable options include navigational mode 1002, non-navigational mode 1003 and filter mode 1004. In case the user selects a navigational mode, the search for the one or more keywords is performed in the navigational elements. In case the user selects a non-navigational mode, the search for the one or more keywords is performed in the non-navigational elements. The said filter mode 1004 comprises element types for both the navigational mode as well as navigational mode. The filter mode 1004 is to be used in conjunction with the navigational mode 1002 and/or the non-navigational mode 1003. The element types include text 1005, video 1006 and image 1007. If the navigational mode 1002 is selected by the user, he can further select the element types text 1005, image 1007 and video 1006. If the non-navigational mode 1003 is selected by the user, he can further select the element types text 1005 and image 1007. It is to be understood that if no filter criteria is selected by the user, it indicates selection of all applicable element types.

As illustrated in FIG. 11, the Graphic User Interface (GUI) 1100 is advanced version of GUI depicted in FIG. 10. The GUI 1100 comprises one or more selectable options. The GUI 1100 comprises a text field 1101 for entering one or more keywords. The selectable options include navigational mode 1102, non-navigational mode 1103, default/normal mode 1104, filter mode and miscellaneous mode. In case the user selects a navigational mode 1102, the search for the one or more keywords in the navigational elements. In case the user selects a non-navigational mode 1103, the search for the one or more keywords in the non-navigational elements. The default/normal mode 1104 includes both navigational mode and non-navigational mode. The filter mode comprises element types for both the navigational mode as well as navigational mode. Also, the filter mode may include one or more options for visually distinguishing the searched keywords on the webpage. The filter mode is to be used in conjunction with the navigational mode, non-navigational mode and the default mode. The element types include text 1105, image 1106 and video 1107. If the navigational mode 1102 is selected by the user, he can further select the element types text 1105, image 1106 and video 1107. If the non-navigational mode 1103 is selected by the user, he can further select the element types text 1105 and image 1106. It is to be understood that if no filter criteria is selected by the user, it indicates selection of all applicable element types. The miscellaneous mode may select miscellaneous options such as preview pane 1108, auto-play 1109 and multi-key search options 1110. The selection of pre-view pane option displays the content of the webpage containing the one or more keywords in one or more pre-view panes. The selection of auto-play option auto plays the contents of one or more navigational videos in one or more user interfaces. The multi-key search option 1111 provides the user to enter a plurality of keywords on the GUI.

The options for visual distinguishing include one or more: font changes, effects, color change and the likes. The font changes may include change in font size or font style of the text matching the one or more keyword in the webpage content. Effects such as shadows, outline, 3D effects and the likes may also be provided to the text matching the one or more keyword in the webpage content. Colour changes include change in foreground colour or background colour of the text matching the one or more keyword. The above mentioned examples are not to be taken as limiting and the term “visual distinguishing” includes other means of visual distinguishing known in the prior arts. Both FIG. 10 and FIG. 11 disclose colour options for visual distinguishing as depicted by reference numerals 1008 and 1112 respectively.

FIG. 12 illustrates a HTML source code of webpage and performing a search for the one or more keyword in the HTML source code, in accordance with an embodiment of the present disclosure.

As illustrated, the keyword “ENGLAND” is searched in html tags associated with the webpage content. The keyword “ENGLAND” is denoted by reference numeral 1201. The keyword “ENGLAND” is found in navigational html tag <a> denoted by reference numeral 1203 (represented by a solid rectangle). The keyword “ENGLAND” is also found in the non-navigational tag <p> and is denoted by reference numeral 1202 (represented by dotted rectangle). In accordance with the search mode defined by the user, the keyword “ENGLAND” will be highlighted in the visual content of the webpage corresponding to said <a> and <p> html tags and are denoted by reference numeral 1204 and 1205 respectively.

FIG. 13 illustrates performing a search for the one or more keywords in the navigational elements present in the webpage content, in accordance with an embodiment of the present disclosure.

As can be seen, FIG. 13 denotes webpage 1300 comprising navigational as well as non-navigational elements. Reference numeral 1301 denotes the navigational element and reference numeral 1302 denotes the non-navigational element. In this use case, the user has restricted the search mode as navigational mode which causes the search for the one or more keywords to be performed only in the navigational elements of the webpage content. Accordingly, the keyword “ENGLAND” is searched only in the navigational elements 1301 and is visually distinguished (represented by dotted circle) from the non-matching navigational text. It is also to be noted that no search is conducted in the non-navigational element of the webpage content and although the keyword “ENGLAND” (represented by solid circle) is present in the non-navigational element, the same is not visually distinguished from non-matching text.

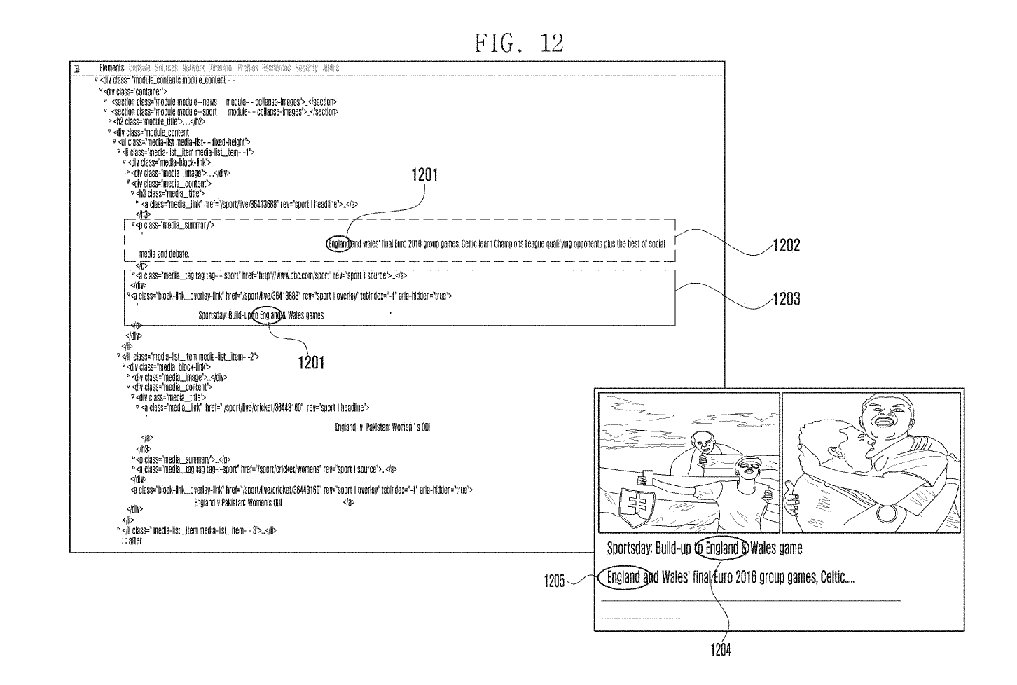

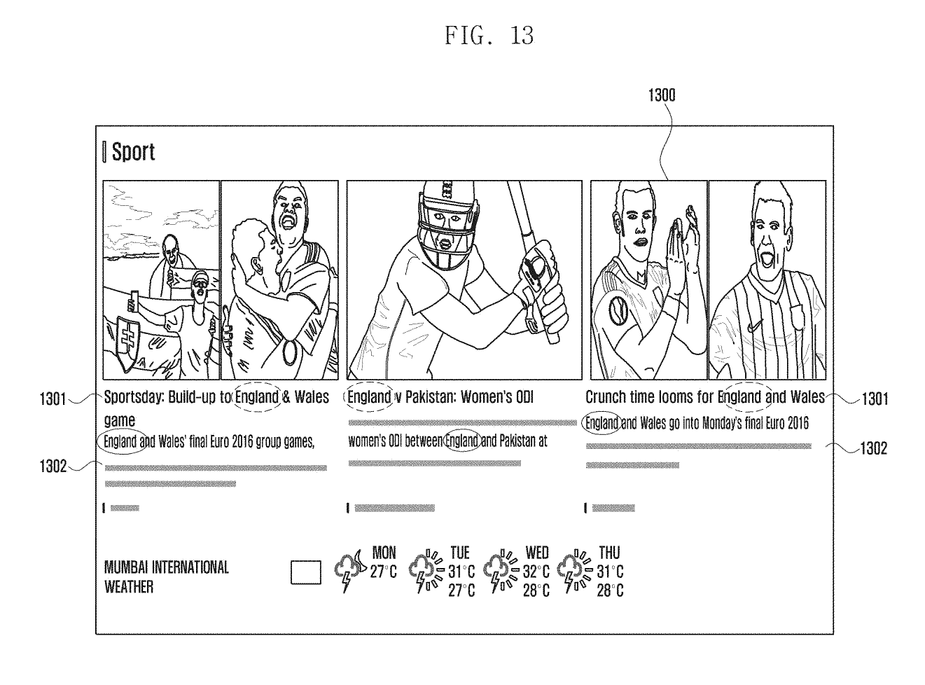

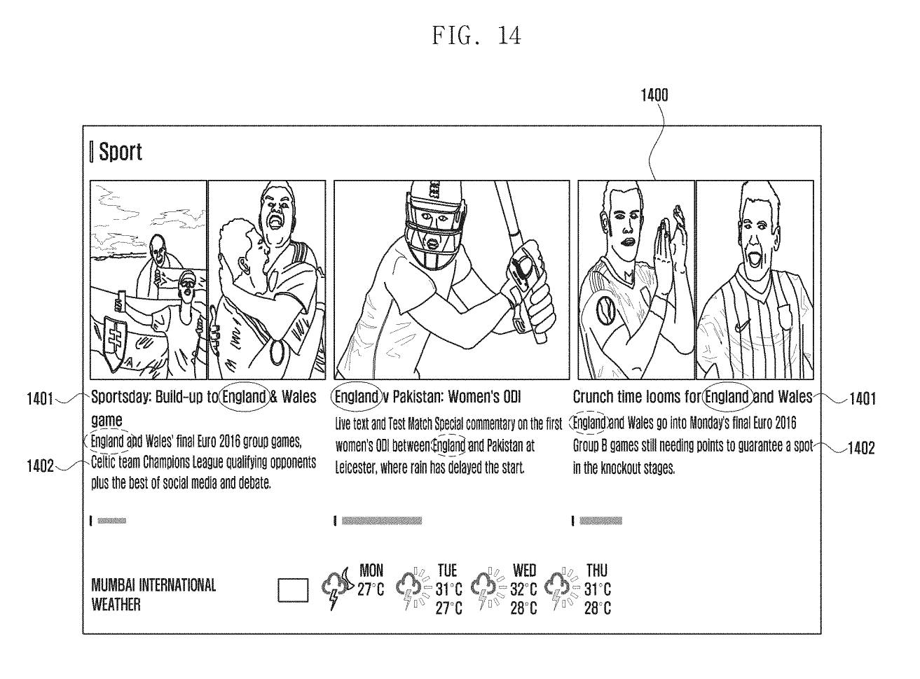

FIG. 14 illustrates performing a search for the one or more keywords in the non-navigational elements present in the webpage content, in accordance with an embodiment of the present disclosure.

As can be seen, FIG. 14 denotes webpage 1400 comprising navigational as well as non-navigational elements. Reference numeral 1401 denotes the navigational element and reference numeral 1402 denotes the non-navigational element. In this use case, the user has restricted the search mode as non-navigational mode which causes the search for the one or more keywords to be performed only in the non-navigational elements i.e. 1402 of the webpage content. Accordingly, the keyword “ENGLAND” is searched only in the non-navigational elements 1402 and is visually distinguished (represented by dotted circle) from the non-matching non-navigational text. It is also to be noted that no search is conducted in the navigational element of the webpage content and although the keyword “ENGLAND” (represented by solid circle) is present in the navigational elements 1401, the same is not visually distinguished from non-matching text.

FIG. 15 illustrates performing a search for the one or more keywords in the navigational as well as non-navigational elements present in the webpage content, in accordance with an embodiment of the present disclosure.

As can be seen, FIG. 15 denotes webpage 1500 comprising navigational as well as non-navigational elements. Reference numeral 1501 denotes the navigational element and reference numeral 1502 denotes the non-navigational element. In this use case, the user has restricted the search mode as normal mode i.e. navigational as well as non-navigational mode which causes the search for the one or more keywords to be performed in the navigational element as well as non-navigational elements of the webpage content. Accordingly, the keyword “ENGLAND” is searched in the navigational elements 1501 as well as non-navigational elements 1502. The matched navigational keywords (represented by solid circle) are visually distinguished from the matched non-navigational keywords (represented by dotted circles). The user can choose to highlight the area containing the one or more keyword as navigational element in same colour as the area containing the one or more keyword as non-navigational element. Alternatively, the user can choose to highlight the area containing the one or more keyword as navigational element in a different colour than the area containing the one or more keyword as non-navigational elements.

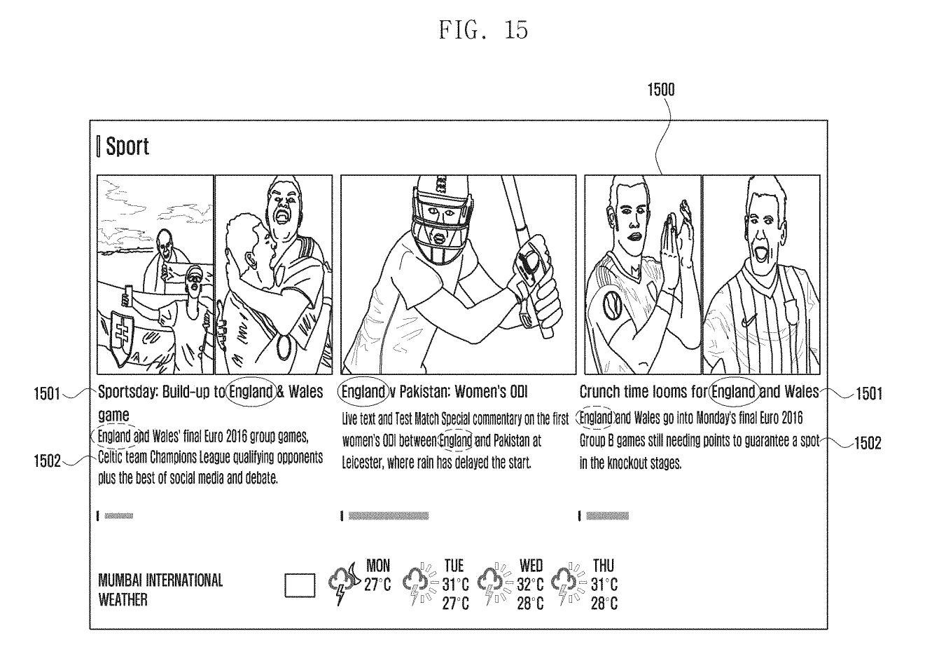

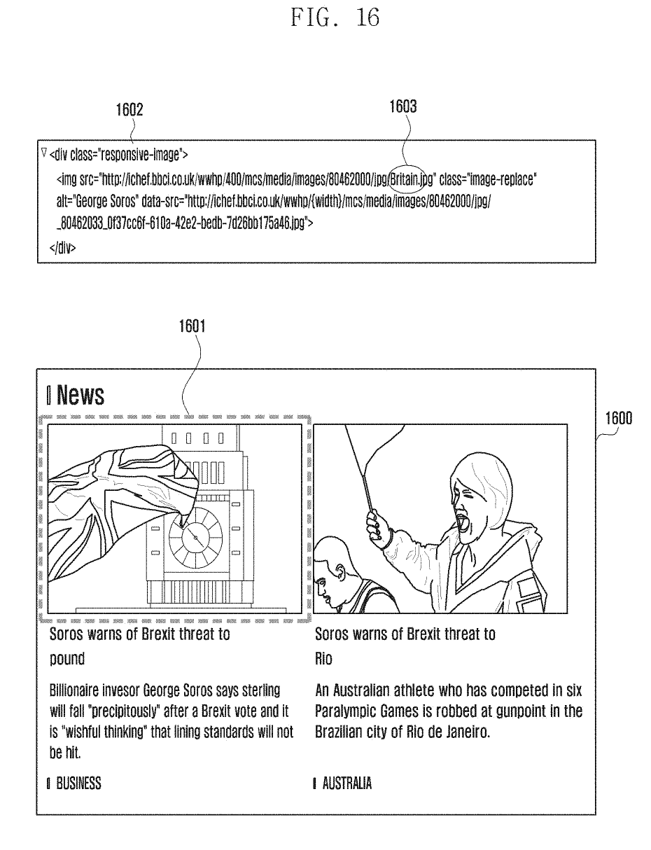

FIG. 16 illustrates a use case for performing a search for the one or more keywords in the html tags, in accordance with an embodiment of the present disclosure. FIG. 16 denotes webpage 1600 retrieved by the web browser when the user enters the keyword “BRITAIN”. As can be seen, the webpage 1600 comprises navigational elements as well as non-navigational element. It can be seen that non-navigational image depicted by reference numeral 1601 is highlighted (outlined by dotted lines). The non-navigational image is highlighted because the present disclosure performs the search for the keyword “BRITAIN” in the html tags associated with the webpage. The source code for the said non-navigational image is depicted by reference numeral 1602 which indicates the html tag element and the attribute property of the said image. As depicted by reference numeral 1603, the keyword “BRITAIN” is present in the attribute value of the attribute property of the said non-navigational image 1601. The present disclosure therefore highlights the non-navigational image 1601 although the keyword “BRITAIN” is not present anywhere in visible content of the webpage 1600.

FIG. 17 illustrates a use case for performing a search for the one or more keywords in the information associated with the html tags, in accordance with an embodiment of the present disclosure.

FIG. 17 denotes webpage 1700 retrieved by the web browser when the user enters the keyword “DOPING”. The content of the webpage 1700 are shown by reference numeral 1701, 1702 and 1703. As represented, a tick mark 1708 is shown corresponding to the content 1702 although no text matching the keyword “DOPING” is present in the navigational elements of the content 1702. The said tick mark represents that the keyword “DOPING” is present in the information associated with the navigational element of said content. The information includes content of the “destination page” indicated by the source code 1704 of the destination page. It is to be noted that the keyword may be in visual content or in attribute value of html tags of the destination webpage. As indicated by reference numeral 1706, the keyword “DOPING” is present in the visual content of the destination page as shown in source code 1704 of the destination page 1705. Also, the word “DOPING” is highlighted in the navigational element of content 1701 and is represented by reference numeral 1707. However, as the said keyword “DOPING” is not present in information associated with the navigational element of content 1701, a tick mark is not shown. It is to be understood that any other visual indication or a combination of visual indication can be used instead of a tick mark to represent the presence of keyword in the information associated with the html tags.

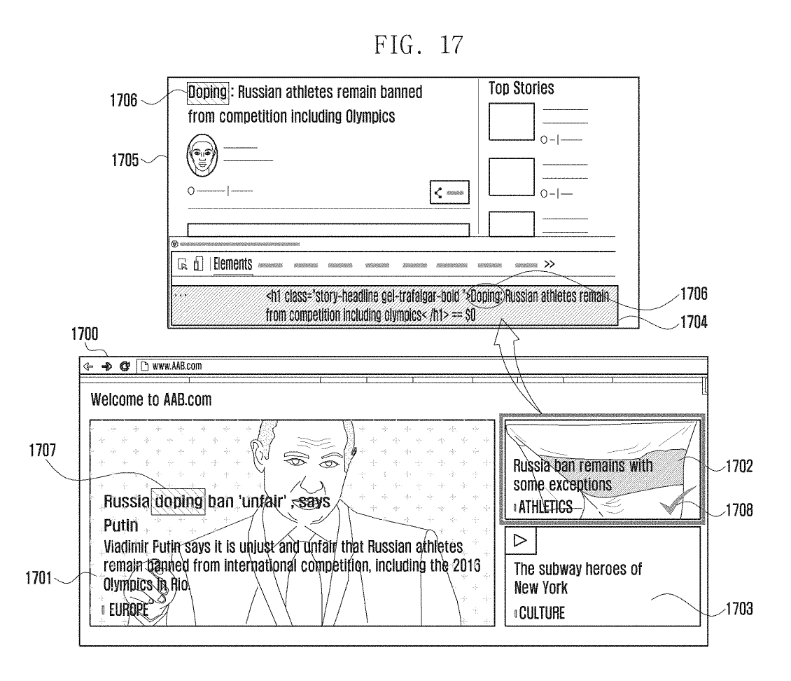

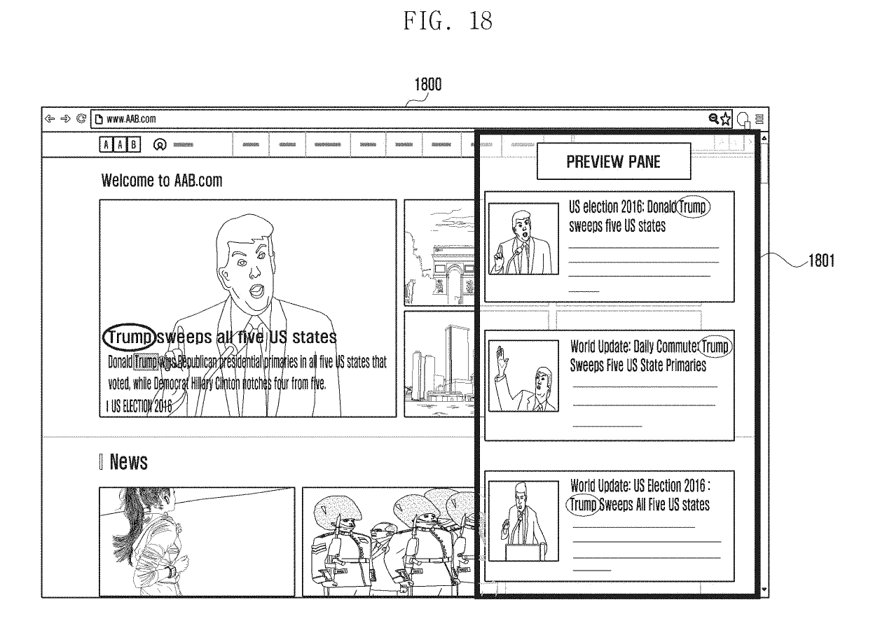

FIG. 18 illustrates a use case for viewing the one or more contents comprising one or more keyword in a pre-view pane, in accordance with an embodiment of the present disclosure. FIG. 18 denotes webpage 1800 retrieved by the web browser when the user enters the keyword “TRUMP”. A lot of navigational elements having the keyword “TRUMP” may be present in the webpage content and for viewing these elements user has to click on such elements one by one which is very frustrating task for user. As can be seen, the content of the webpage comprising the keyword “TRUMP” is highlighted in the webpage (as represented by solid circle). Also, the contents comprising the keyword “TRUMP” are shown in a pre-view pane denoted by reference numeral 1801. The present disclosure shows the content of the webpage comprising the keyword in a pre-view pane so that the users do not have to click on each searched element one by one. With the help of the preview pane 1801, the user can filter out the content of the webpage comprising the one or more keywords easily and quickly.

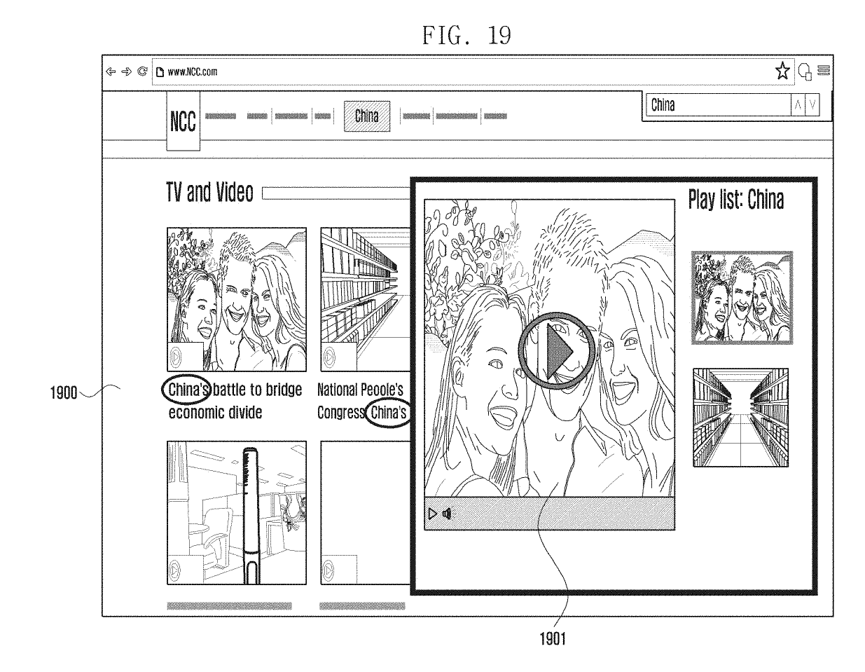

FIG. 19 illustrates a use case for auto-playing one or more navigational videos comprising the one or more keyword, in accordance with an embodiment of the present disclosure. FIG. 19 denotes webpage 1900 retrieved by the web browser when the user enters the keyword “CHINA”. A lot of videos having the keyword “CHINA” may be present in the webpage content and for viewing these videos user has to click on such videos one by one which is very frustrating task for user. As can be seen, the content of the webpage comprising the keyword “CHINA” is highlighted in the webpage (as represented by solid circle). Also, when the user selects an option for auto-playing of navigational videos, all the searched and highlighted videos can be played automatically one by one in pop up window in browser as shown by reference numeral 1901.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. In addition, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

While certain present preferred embodiments of the invention have been illustrated and described herein, it is to be understood that the invention is not limited thereto. Clearly, the invention may be otherwise variously embodied, and practiced within the scope of the following claims.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for searching for at least one keyword, the method comprising:
receiving a user input for searching within content, the user input comprising at least one of a search mode or the at least one keyword;
determining a property associated with the search mode, the property indicating that the search for the at least one keyword be restricted;
performing a search for the at least one keyword within the content according to the property associated with the search mode; and
displaying information associated with the performed search for the at least one keyword,
wherein the search mode comprises a navigational mode, a non-navigational mode, or a normal mode.

2. The method of claim 1, wherein the performing the search for the at least one keyword comprises searching for the at least one keyword in a navigational html tag within the content when the search mode is the navigational mode.

3. The method of claim 1, wherein the performing the search for the at least one keyword comprises searching for the at least one keyword in a non-navigational html tag within the content when the search mode is the non-navigational mode.

4. The method of claim 1, further comprising performing a search for a tag, wherein the tag is categorized as navigational or non-navigational.

5. The method of claim 1, wherein the content comprises:
a visual content of a webpage; and
one or more attributes associated with the visual content.

6. The method of claim 1, wherein the search is based on information associated with one or more html tags.

7. The method of claim 1, wherein the navigational mode comprises navigational text, navigational image and navigational video and wherein the non-navigational mode comprises non-navigational text and non-navigational image.

8. The method of claim 1, wherein performing the search for the at least one keyword in one or more html tags comprises:
fetching all html tags associated with the content;
performing a first search on the fetched html tags to obtain a first set of html tags, wherein each of the first set of html tags include a tag property matching the property of the search mode; and
performing a second search on the first set of html tags to obtain a second set of html tags, wherein each of the second set of html tags include the at least one keyword.

9. The method of claim 1, wherein performing the search for the at least one keywords in one or more html tags comprises:
fetching all html tags associated with the content;
performing a first search on the fetched html tags to obtain a first set of html tags, wherein each of the first set of html tags include the at least one keyword; and
performing a second search on the first set of html tags to obtain a second set of html tags, wherein each of the second set of html tags include a tag property matching the property of the search mode.

10. The method of claim 1, further comprising:
in response to receiving the at least one keyword performing at least one of
visually distinguishing an area containing the at least one keyword from an area devoid of the at least one keyword,
visually distinguishing an area containing the at least one keyword as a navigational element from an area devoid of the at least one keyword as a non-navigational element,
visually distinguishing an area containing a first keyword from an area containing a second key word,
visually distinguishing an area containing first keyword as a navigational element from an area containing a second keyword as a non-navigational element,
displaying the navigational element containing the at least one keyword in one or more pre-view panes on a user interface,
displaying the non-navigational elements containing the at least one keyword in the one or more pre-view panes on the user interface,
auto-playing content of one or more navigational images on the user interface, and
auto-playing contents of one or more navigational videos on the user interface.

11. An electronic device for searching of at least one keyword, the device comprising:
a display;
a communication circuit configured to communicate with a server;
a memory configured to store a keyword search application;
a processor configured to be electrically connected with the display, the communication circuit, and the memory and execute the keyword search application,
wherein the processor is configured to:
receive a user input for searching within content, wherein the user input comprising at least one of a search mode and the at least one keyword;
determine a property associated with a search mode, wherein the property indicates that the search for the at least one keyword be restricted, and
perform a search for the at least one keyword within the content according to the property associated with the search mode; and
control the display to display information associated with the search for the at least one keyword,
wherein the search mode comprises a navigational mode, a non-navigational mode, or a normal mode.

12. The electronic device of claim 11, wherein the processor is configured to search for the at least one keyword in a navigational html tag within the content when the search mode is the navigational mode.

13. The electronic device of claim 11, wherein the processor is configured to search for the at least one keyword in a non-navigational html tag within the content when the search mode is the non-navigational mode.

14. The electronic device of claim 11, wherein the processor is configured to search for a tag, wherein the tag is categorized as navigational or non-navigational.

15. The electronic device of claim 11, wherein the search is based on information associated with one or more html tags.

16. A non-transitory computer readable medium comprising program code that, when executed by at least one processor, causes the at least one processor to:
receive a user input for searching within content, wherein the user input comprising at least one of a search mode and at least one keyword;
determine a property associated with a search mode, wherein the property indicates that the search for the at least one keyword be restricted, and
perform a search for the at least one keyword within the content according to the property associated with the search mode; and
display information associated with the search for the at least one keyword
wherein the search mode comprises a navigational mode, a non-navigational mode, or a normal mode

17. The non-transitory computer readable medium of claim 16, further comprising program code that, when executed by at least one processor, causes the at least one processor to:
search for the at least one keyword in a navigational html tag within the content when the search mode is the navigational mode

18. The non-transitory computer readable medium of claim 16, further comprising program code that, when executed by at least one processor, causes the at least one processor to:
search for the at least one keyword in a non-navigational html tag within the content when the search mode is the non-navigational mode.

19. The non-transitory computer readable medium of claim 16, further comprising program code that, when executed by at least one processor, causes the at least one processor to:
search for a tag, wherein the tag is categorized as navigational or non-navigational.

20. The non-transitory computer readable medium of claim 16, wherein the search is based on information associated with one or more html tags.
